(19) United States
(12) Patent Application Publication
(10) Pub. No.: US 2021/0325866 A1
(43) Pub. Date: Oct. 21, 2021

(54) A Ground Station for an Unmanned Aerial Vehicle (UAV)

(71) Applicant: XDynamics Limited, Hong Kong (HK)

(72) Inventor: Man Wah Chan, Mid-Levels (HK)

(21) Appl. No.: 16/492,330

(22) PCT Filed: Mar. 28, 2018
(86) PCT No.: PCT/CN2018/080769

§ 371 Date: Sep. 9, 2019

(51) Int. Cl. G05D 1/00; G05G 1/01; G05G 1/10; G05G 1/04; G05G 13/00

(52) U.S. Cl. CPC G05D 1/0016; G05G 1/01; G05G 1/10; B64C 39/024; G05G 13/00; B64C 2201/146; G05G 1/04

(57) ABSTRACT

The invention relates to a ground station for an unmanned aerial vehicle (UAV) comprising a control panel provided at a housing of the ground station; at least one control assembly arranged at the control panel, the control assembly comprising at least a first, turnable user input unit and a second user input unit; wherein the first, turnable user input unit is arranged to surround the second user input unit to thereby allow an ergonomic, one-handed operation of the first and the second user input units by a user.

### FIELD OF THE INVENTION

The invention relates to a ground station for wirelessly controlling operation of a UAV such as, but not limited to, a drone or a multi-copter.

### BACKGROUND OF THE INVENTION

A multi-rotor or multi-copter, often referred to as a ‘drone’, is a rotorcraft normally with more than two rotors. An advantage of a multi-copter aircraft is the simpler rotor mechanics required for flight control. Unlike single- and double-rotor helicopters which use complex variable pitch rotors whose pitch varies as the blade rotates for flight stability and control, multi-copters typically use fixed-pitch blades. Consequently, control of vehicle motion is achieved by varying the relative speed of each rotor to change the thrust and torque produced by each rotor.

Conventionally available UAVs such as multi-copters or the like typically use a hand held device commonly referred to as a ‘ground station’ to remotely control the multi-copter via a wireless link or connection. Each of the ground station and the multi-copter are provided with suitable wireless transceivers for sending and receiving wireless signals including flight control signals, telemetry signals and the like including photography and/or videography signals. Many of such conventionally available multi-copters are controlled in flight through a first person view (FPV) image received from a camera on the multi-copter and viewed via a screen associated with the ground station. It is common for the screen used to not comprise an integral component of the ground station, but to comprise a generic electronic device such as a smart phone, phablet or tablet computer mounted on a bracket provided by the ground station. User input for controlling the multi-copter or parts of the multi-copter are thus generally provided by the input means of such electronic devices, and additionally or alternatively, via traditional input means such as one or more control sticks or joysticks, switches, knobs or buttons mechanically actuatable to provide control instructions to the multi-copter.

One problem encountered with the use of a generic electronic device and/or traditional input means for inputting user instruction, especially in view of the growing complexity of multi-copters and their ever-advancing functions, is that it could be not always easy or even difficult for the user to manage the various input means seamlessly or simultaneously when controlling operation of the multi-copters via the ground station. The need for a multi-copter to perform aerial photography or videography in addition to the flight control unavoidably complicates operation of the ground station further. Consequently, it is not uncommon for a user to find the typical UAV ground station arrangement as afore-described as being user unfriendly, complicated or difficult to control or manage, which diminishes the quality of the user's experience in operating the UAV.

### OBJECTS OF THE INVENTION

An object of the present invention is to provide an improved ground station for an unmanned aerial vehicle (UAV) such as a drone, multi-copter or other type of UAV.

Another object of the present invention is to provide a ground station for a UAV such as a multi-copter for an improved user experience.

A further object of the present invention is to mitigate or obviate to some degree one or more problems associated with known ground stations for UAVs, or at least to provide a useful alternative.

The above objects are met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a ground station for an unmanned aerial vehicle (UAV). The ground station comprises a control panel provided at a housing of the ground station; at least one control assembly arranged at the control panel, the control assembly comprising at least a first, turnable user input unit and a second user input unit; wherein the first, turnable user input unit is arranged to surround the second user input unit to thereby allow an ergonomic, one-handed operation of the first and the second user input units by a user.

In a second main aspect, the invention provides a control device comprising a control panel provided at a housing of the device; at least one control assembly arranged at the control panel, the control assembly comprising at least a first, turnable user input unit and a second user input unit; wherein the first, turnable user input unit is arranged to surround the second user input unit at a plane of the control panel to thereby allow an ergonomic, one-handed operation of the first and the second user input units by a user.

In a third main aspect, the invention provides a control assembly for use at a control device comprising at least a first, turnable user input unit and a second user input unit; wherein the first, turnable user input unit is arranged to surround the second user input unit to thereby allow an ergonomic, one-handed operation of the first and the second user input units by a user.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figure, of which:

FIG. 1 perspective view of an embodiment of a ground station according to the invention; and

FIG. 2 is a top view of the ground station of FIG. 1.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

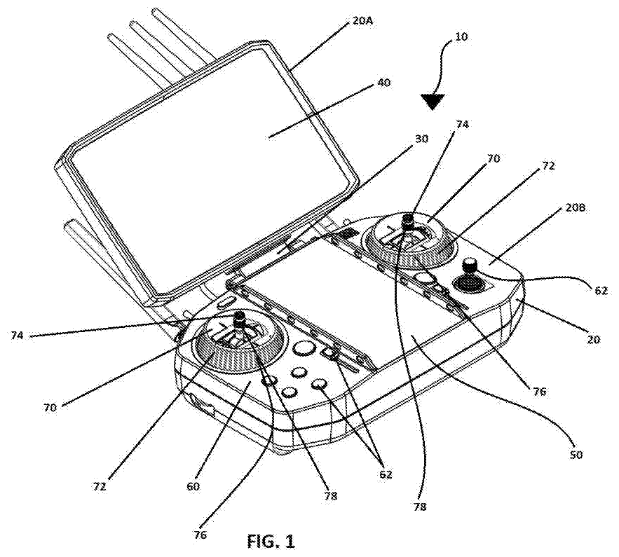

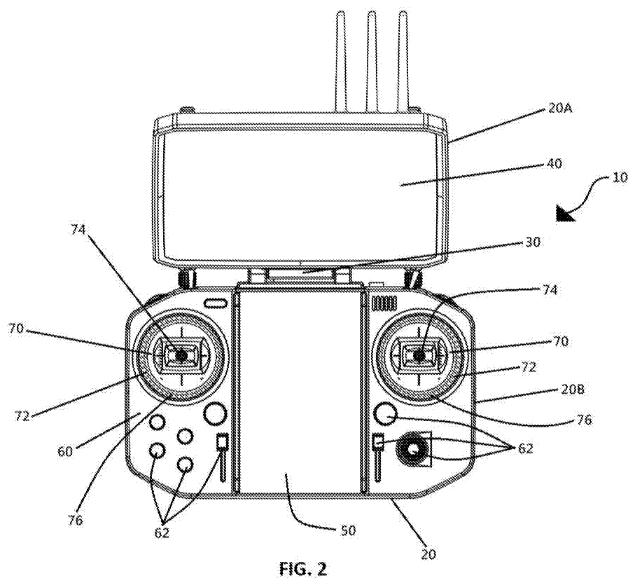

Referring to FIGS. 1 and 2, provided is an embodiment of a ground station 10 for a multi-copter. In the following description, embodiments of a multi-copter are described by way of example of an unmanned aerial vehicle (UAV) or a drone. The ground station 10 comprises a housing 20. In preferred embodiments, the housing 20 may be in two parts and may comprise a clam shell housing having a first housing member 20A and a second housing member 20B. The first housing member 20A is preferably movable relative to the second housing member 20B between a closed position overlaying said second housing member 20B and an open position as seen in the figures.

The first housing member 20A is preferably pivotally mounted on said second housing member 20B. The open position as shown in the drawings can be a fully open position, but the first housing member 20A may also be opened to any position between its closed and open positions as required by a user. A pivot connection 30 between the first and second housing members 20A, 20B may provide sufficient friction between the housing members to enable the first housing member 20A to hold its position when opened to any position between its closed and opened positions, although it will be understood that any suitable mechanism to effect opening of the first housing member 20A to any position between its closed and open positions may be utilised.

The ground station 10 preferably includes at least one screen 40 provided or mounted on the first housing member 20A. A second screen 50 may optionally be provided or mounted on the second housing member 20B. The arrangement is such that both screens 40, 50 are viewable by a user at least when the housing members 20A, 20B are in their fully open position or near their fully open position.

The ground station 10 may further comprise a control panel 60 provided at, for example, the second housing member 20B. The control panel 60 may comprise one or more traditional input means such as, but not limited to, one or more control sticks or joysticks, buttons, knobs and/or switches 62, as shown in the figures, for inputting user instructions via the ground station 10. In the embodiment as shown in the figures, the control panel 60 is configured to comprise at least one control assembly 70 having at least a first, turnable user input unit 72 and a second user input unit 74 for inputting user instructions. Particularly, the first, turnable user input 72 is preferred to surround the second user input unit 74, such as the configuration as shown in the figures, to thereby allow an ergonomic, one-handed operation of both user input units 72, 74 by a user. For example, the user may use his thumb and index finger of one hand to hold, pinch, support or manipulate the second user input unit 74 to control or operate one or more first functional aspect of the drone, while his middle finger or other remaining fingers of the same hand may turn the first user input unit 72 to control, adjust or operate one or more second functional aspect of the drone. Control and operation of the first and second functional aspects can thus be achieved seamlessly and/or simultaneously, and yet in an ergonomic manner with the benefit of the specific arrangement and configuration of the control assembly 70 of the present invention.

In one embodiment, it is preferred that the first, turnable user input unit 72 be arranged to surround the second user input unit 74 in a plane of the control panel 60 to facilitate operation of the ground station 10 by the user, that is, with the control assembly 70 being arranged on the same plane with the other input means 62 at the control panel 60 for a convenient access thereof by the user during an operation of the ground station 10. The plane may comprise a top surface of the control panel 60. In the embodiment as shown in the figures, the first, turnable user input unit 72 may comprise a wall protruding from the plane of the control panel 60, and preferably, a cylindrical wall rotatable about a central axis to allow a turning actuation of the first input unit 72. More preferably, the first, turnable user input unit 72 may comprise a wall which is configured to incline inwardly toward the surrounded second user input unit 74 with respect to the plane of the control panel 60, such as, in the form of a frustum-shaped wall, for example.

In one specific embodiment, the first, turnable user input unit 72 is preferred to comprise a turnable ring member which surrounds the second user input unit 74, and more preferably, with the second user input unit 74 being located centrally within the ring member. It will be understood, however, the present invention is not limited to the first, turnable user input unit 72 as being provided in the form of and/or to comprise a ring-shaped member, but any configurations such as, but not limited to, a polygonal ring member, or a turnable knob with the second user input unit 74 arranged thereon or embedded therein, shall also be encompassed, as long as the first user input unit 72 is turnably actuatable and is adapted to define a peripheral edge or border within which the second user input unit 74 is located. For example, the first user input unit 72 can be provided in the form of a turnable, hexagonal knob having a substantially planar top surface, with the second user input unit 74 being movably arranged thereon within the defined peripheral edge of the hexagonal knob.

In one preferred embodiment, the first user input unit 72 may comprise at least one gripping member 76 arranged at the wall, such as at an external side of the wall. The gripping member 76 can be provided with, formed of and/or comprise any grip patterns and/or configurations capable of enabling or enhancing a frictional engagement between the first user input unit 72 and the user's finger or fingers. For example, at least part of the gripping member 76 may comprise a corrugated surface. The gripping member 76 can be provided as a separate part adapted to snugly fit on or connect to a part of the first user input unit 72, such as at the external side wall of the unit 72. Alternatively, the gripping member 76 can be integrally formed with the first user input unit 72.

In one further embodiment, the second user input unit 74 can be made pivotable with respect to the plane of the control panel 60. For example, the second user input unit 74 can made movable in at least one of a horizontal direction (i.e. an x-direction), a vertical direction (i.e. a y-direction), a diagonal direction and/or any arbitrary direction along the plane of the control panel 60. Additionally or alternatively, the second user input unit 74 may also be movable rotatably, and/or transversely across the plane of the control panel 60 (i.e. a z-direction). Preferably, the second user input unit 74 comprises at least one protruding member 78, such as a stick member, protruding from the plane of the control panel 60 to allow an easy accessing or holding by the user. More preferably, the second user input unit 74 is adapted to protrude above the wall of the first, turnable user input unit 72, such that the protruded portion of the second user input unit 74 can be easily accessible by the user's fingers while the first user input unit 72 as being turnable by the other fingers of the same hand of the user.

The aforesaid arrangement of the control assembly 70 of the present invention is advantageous in way that it allows an ergonomic, one-handed operation of the first and the second user input units 72, 74 of the control assembly 70 by the user when operating the ground station. It is also preferred to arrange two control assemblies 70 at the control panel 60 of the ground station 10, as shown in the figures, each of which being positioned to be easily operable by a respective hand of the user. In use, for example, the user may position the thumb and the index finger of his left hand to hold or to manipulate the left, second user input unit 74, and the remaining one or more fingers of his left hand to turn the left, first user input unit 72 for a seamless and/or simultaneous operation of both user input units 72, 74. Similarly, the user may, at the same time, position the thumb and the index finger of his right hand to hold or to manipulate the right, second user input unit 74, and the remaining one or more fingers of his right hand to smoothly turn the right, first user input unit 72, without affecting operation of the right, second user input unit 74. The present invention is particularly useful for a one-man, multi-operations of the ground station, i.e. the user is required to manage more than one functional aspect of the drone, for example, both the flight control of the drone and the photography and/or videography by the camera and/or video-camera of the drone. The control assembly 70 of the present invention thus allows an ergonomic operation and control over both of these, different functions. For example, the user may easily hold or manipulate the control stick of the second user input unit 74 by using his thumb and his index finger for flight control, such as to control the roll, pitch, yaw and/or throttle of the drone. At the same time, the user may slide or roll onto the turnable ring member of the first user input unit 72 by his other fingers, such as his middle finger, to thereby adjust coarsely and/or finely, the focusing and zooming functions of the camera and/or video-camera for the purpose of aerial photography and/or videography. It is understandable that, during such a one-man, dual functions operation of the ground station in which the user will be both the drone pilot and the photographer and/or videographer, it would be very difficult, if not impossible, for one to finitely adjust focusing and zooming of the camera or video camera while flying a drone in an ergonomic manner with the existing, traditional ground stations or controllers.

In one other aspect of the present invention, there is provided a control device, such as but not limited to, a ground station for an unmanned aerial vehicle (UAV) as described above. The control device comprises a control panel arranged at a housing of the device, and at least one control assembly arranged at the control panel. The control assembly comprises at least a first, turnable user input unit and a second user input unit, with the first, turnable user input unit being arranged to surround the second user input unit at a plane of the control panel to thereby allow an ergonomic, one-handed operation of the first and the second user input units by a user. The control device can be utilised in both amateur and professional applications, for example, in the cinematographic industry.

In one further aspect of the present invention, there is provided a control assembly, such as one as described in the various embodiments above for use at a control device, such as but not limited to, a ground station for use in an unmanned aerial vehicle (UAV). The control assembly comprises at least a first, turnable user input unit and a second user input unit, with the first, turnable user input unit being arranged to surround the second user input unit to thereby allow an ergonomic, one-handed operation of the first and the second user input units by a user.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such prior art does not constitute an admission that the prior art forms a part of the common general knowledge in the art.

1. A ground station for an unmanned aerial vehicle (UAV), comprising:
a control panel provided at a housing of the ground station;
at least one control assembly arranged at the control panel, the control assembly comprising at least a first, turnable user input unit and a second user input unit;
wherein the first, turnable user input unit is arranged to surround the second user input unit to thereby allow an ergonomic, one-handed operation of the first and the second user input units by a user.

2. The ground station according to claim 1, wherein the first, turnable user input unit is arranged to surround the second user input unit in a plane of the control panel.

3. The ground station according to claim 2, wherein the first, turnable user input unit comprises a wall protruding from the plane of the control panel.

4. The ground station according to claim 3, wherein the first, turnable user input unit comprises a cylindrical wall.

5. The ground station according to claim 3, wherein the first, turnable user input unit comprises an inwardly inclined wall with respect to the plane of the control panel.

6. The ground station according to claim 3, wherein the first, turnable user input unit comprises at least one gripping member at an external side of the wall.

7. The ground station according to claim 6, wherein at least part of the gripping member comprises a corrugated surface.

8. The ground station according to claim 1, wherein the first, turnable user input unit comprises a ring member.

9. The ground station according to claim 2, wherein the second user input unit is pivotable with respect to the plane of the control panel.

10. The ground station according to claim 2, wherein the second user input unit is movable in at least one of a horizontal direction, a vertical direction and a diagonal direction along the plane of the control panel.

11. The ground station according to claim 1, wherein the second user input unit is rotatably movable.

12. The ground station according to claim 2, wherein the second user input unit is transversely movable across the plane of the control panel.

13. The ground station according to claim 2, wherein the second user input unit comprises at least one stick member protruding from the plane of the control panel.

14. The ground station according to claim 1, wherein the second user input unit is centrally located relative to the first, turnable user input unit.

15. The ground station according to claim 3, wherein the second user input unit is adapted to protrude above the wall of the first, turnable user input unit.

16. The ground station according to claim 1, wherein the first and the second user input units are adapted to be simultaneously operable by one hand of the user.

17. The ground station according to claim 1, wherein the at least one control assembly comprises two control assemblies each of which is positioned on the control panel to be operable by a respective hand of the user.

18. A control device, comprising:
a control panel provided at a housing of the device;
at least one control assembly arranged at the control panel, the control assembly comprising at least a first, turnable user input unit and a second user input unit;
wherein the first, turnable user input unit is arranged to surround the second user input unit at a plane of the control panel to thereby allow an ergonomic, one-handed operation of the first and the second user input units by a user.

19. A control assembly for use at a control device, comprising:
at least a first, turnable user input unit and a second user input unit;
wherein the first, turnable user input unit is arranged to surround the second user input unit to thereby allow an ergonomic, one-handed operation of the first and the second user input units by a user.
